(19) United States
(12) Patent Application Publication
(10) Pub. No.: US 2026/0185819 A1
(43) Pub. Date: Jul. 2, 2026

(54) LOAD PORT

(71) Applicant: Sinfonia Technology Co., Ltd., Tokyo (JP)

(72) Inventors: Hiroto Kano, Tokyo (JP); Tatsuru Ogawa, Tokyo (JP); Tatsuya Miura, Tokyo (JP)

(21) Appl. No.: 19/551,922

(22) Filed: Feb. 27, 2026

Related U.S. Application Data
(63) Continuation of application No. PCT/JP2024/029124, filed on Aug. 15, 2024.

(30) Foreign Application Priority Data
Aug. 31, 2023 (JP) 2023-141663

(51) Int. Cl. G01B 11/06

(52) U.S. Cl. CPC G01B 11/06

(57) ABSTRACT

A load port includes: a base; a mounter mounting thereon a container accommodating substrates; a scanner detecting the substrates; and a determiner making a determination regarding a state of each substrate detected by the scanner, wherein the scanner detects first to third portions of an end surface of each substrate, while a fixed state, in which the container is mounted on the mounter and an angle of the container about a vertical axis with respect to the base is fixed, is maintained, and wherein the determiner determines whether each substrate is normally accommodated in the container by using information on a first position and information on a second position, and calculate an amount of vertical deflection of a substrate normally accommodated in the container by using the information on the first position, the information on the second position, or both, and information on a third position.

### CROSS-REFERENCE TO RELATED APPLICATION

This application is a Bypass Continuation Application of PCT International Application No. PCT/JP 2024/029124, filed Aug. 15, 2024 and designating the United States, the international application being based upon and claiming the benefit of priority from Japanese Patent Application No. 2023-141663, filed on Aug. 31, 2023, the entire contents of which are incorporated herein by reference.

### TECHNICAL FIELD

The present disclosure relates to a load port.

### BACKGROUND

A load port on which a container containing a plurality of wafers (hereinafter referred to as “substrates”) arranged in a vertical direction is placed is known in the related art. Many recent load ports have a mapping function of detecting a status of each substrate in a container. For example, a load port-equivalent part of a substrate loading/unloading device disclosed in Patent Document 1 includes a mounting part on which a cassette (hereinafter referred to as a “container”) is mounted, a substrate detector, and a drive part (referred to as a shutter drive mechanism in Patent Document 1). The substrate detector has a transmission-type optical sensor including a light irradiation part and a light detection part, and is driven to move in an up-down direction by the drive part. The light irradiation part and the light detection part are arranged opposite each other with an end portion of the substrate near the substrate detector in the container in a horizontal direction. When a light irradiated from the light irradiation part is blocked in a certain region in the up-down direction during the up-down movement of the substrate detector, it is determined that a substrate is present in that region.

Patent Document 2 discloses a pitch measurement device that performs mapping of multiple substrates accommodated in a container, which is different from the load port described above. The pitch measurement device is configured to measure an amount of deflection of each substrate due to its own weight. More specifically, the pitch measurement device includes a photoelectric element, a scanning device, and a rotary base on which the container is mounted. The photoelectric element includes a light emitter and a light receiver. The photoelectric element detects a substrate by emitting light to the substrate in the pod using the light emitter and receiving the light reflected from the substrate using the light receiver. In mapping, the scanning device performs a scanning operation of moving the photoelectric element from a predetermined upper end position to a predetermined lower end position multiple times. The rotary base changes a rotation angle of the container at a timing between one scanning operation and the next scanning operation. This detects the height positions of each substrate at multiple points around the rotary base. For each substrate, an amount of deflection is measured by calculating a difference between the height positions of the highest and lowest points.

### PRIOR ART DOCUMENTS

### Patent Documents

Patent Document 1: Japanese laid-open publication No. 2001-7182
Patent Document 2: Japanese Utility Model Registration No. 3177757

In view of the recent trend toward thinner substrates, the present disclosers have been studying and measuring the amount of deflection of substrates in load ports. One objective of the study is to utilize deflection amount information in the operation control for a substrate transfer device that transfers substrates in a container mounted on a load port. However, in the substrate detector described in Patent Document 1, the light emitted from the light irradiation part during the up-down movement is blocked for a similarly long period of time in either a case where the substrate is simply deflected or a case where the substrate is accommodated in the container in an abnormal tilted state. As a result, the substrate detector cannot distinguish whether the substrate normally accommodated in the container is simply deflected or whether the substrate is accommodated in the container in an abnormal state. Thus, it is conceivable to use the photoelectric element described in Patent Document 2 to detect an end surface of the substrate. However, the load port described in Patent Document 1 does not allow the container to be rotated between one scanning operation and the next scanning operation. Therefore, the invention described in Patent Document 2 cannot be directly applied to load ports.

The present disclosure intends to determine whether a substrate is normally accommodated in a container without having to rotate the container and calculate an amount of deflection of the substrate.

### SUMMARY

A load port of a first invention includes: a base having a fixed installation position; a mounter attached to the base and configured such that a container configured to accommodate a plurality of substrates arranged in a vertical direction is mounted on the mounter; a scanner configured to be capable of detecting the plurality of substrates accommodated in the container; and a determiner configured to be capable of making a determination regarding a state of each of the plurality of substrates detected by the scanner, wherein the scanner is configured to be capable of detecting a first portion, a second portion, and a third portion of an end surface of each of the plurality of substrates, the first portion, the second portion, and the third portion being spaced apart from one another in an extension direction of the end face of each of the plurality of substrates, while a fixed state, in which the container is mounted on the mounter and an angle of the container about a vertical axis with respect to the base is fixed, is maintained, and wherein the determiner is configured to determine whether each of the substrates is normally accommodated in the container by using information on a first position which is a vertical position of the first portion and information on a second position which is a vertical position of the second portion, and calculate an amount of vertical deflection of a substrate normally accommodated in the container among the plurality of substrates by using the information on the first position, the information on the second position, or both of the information on the first position and the information on the second position, and information on a third position which is a vertical position of the third portion.

In the present disclosure, the scanner can detect the vertical positions of the first portion, the second portion, and the third portion of the end surface of each of the substrates in a fixed state where the angle of the container with respect to the base is fixed. Then, the determiner can determine whether each of the substrates is normally accommodated in the container. Furthermore, the determiner can calculate the amount of deflection of the substrate normally accommodated in the container. Accordingly, it is possible to determine whether the substrate is normally accommodated in the container and to calculate the amount of deflection of the substrate without rotating the container.

According to a load port of a second invention, in the first invention, the scanner includes: a first sensor configured to be capable of detecting the first portion; a second sensor configured to be capable of detecting the second portion and different from the first sensor; a third sensor configured to be capable of detecting the third portion and different from the first sensor and the second sensor; a support portion configured to support the first sensor, the second sensor, and the third sensor; and a driver configured to be capable of driving and moving the support portion in the vertical direction.

In the present disclosure, the first sensor, the second sensor, and the third sensor can be moved simultaneously in the vertical direction. Therefore, the information on the first position, the information on the second position, and the information on the third position can be acquired simultaneously, depending on a function of the determiner. In this case, an operating time of the scanner can be shortened.

According to the load port of a third invention, in the first or second invention, when the container is in the fixed state, a first support portion configured to support each of the plurality of substrates inside the container is arranged on one side of a center of the container in a predetermined container width direction perpendicular to the vertical direction, a second support portion configured to support each of the plurality of substrates inside the container is arranged on the other side of the center of the container in the container width direction, the first portion is arranged closer to the first support portion than the center of the container in the container width direction, the second portion is arranged closer to the second support portion than the center of the container in the container width direction, and the third portion is arranged between the first portion and the second portion in the container width direction.

In the present disclosure, the first portion, which is located relatively close to the first support portion, and the second portion, which is located relatively close to the second support portion, are hardly deflected. Accordingly, by using the information on the first position and the information on the second position, it is possible to accurately determine whether each of the substrates is located in a normal position inside the container. Furthermore, since a portion located relatively far from the first support portion and the second support portion in the container width direction is easily deflected due to its own weight, the third portion is likely to sag more than the first portion and the second portion. Accordingly, by using the information on the third position, and the information on the first position, the information on the second position, or both of the information on the first portion and the information on the second portion, the amount of deflection of each of the substrates can be accurately calculated.

According to the load port of a fourth invention, in the first or second invention, the scanner includes: a reflective optical sensor including a light emitter configured to emit detection light for detecting the end surface and a light receiver configured to sense the detection light reflected by the end surface; and an angle regulator configured to be capable of regulating an angle of an optical axis of the detection light emitted from the light emitter about the vertical axis.

In the present disclosure, even when substrates of various shapes, sizes, of both of them are handled on the load port, the end surface of each of the substrates can be reliably detected by regulating the angle of the optical axis about the vertical axis.

According to the load port of a fifth invention, in the fourth invention, the plurality of substrates include a plurality of wafers which are semiconductor substrates, and the reflective optical sensor is arranged so that the optical axis is perpendicular to the end surface of each of the plurality of substrates.

Wafers generally have a substantially circular cross section. Accordingly, the configuration in which the angle of the optical axis of the reflective optical sensor about the vertical axis is regulated and the optical axis is arranged substantially perpendicular to the end surface is particularly effective in a load port configured to handle a container which accommodates substrates including wafers.

### BRIEF DESCRIPTION OF DRAWINGS

FIG. 1 is a schematic plan view of an EFEM equipped with a load port according to the present embodiment and its surroundings.

FIG. 2A is a side cross-sectional view of a FOUP, and FIG. 2B is a rear view of the FOUP with its lid removed.

FIGS. 3A and 3B are views showing wafers abnormally accommodated in a FOUP.

FIG. 4 is a perspective view of a load port.

FIG. 5 is a right side view of a load port.

FIG. 6 is a rear view of a load port.

FIGS. 7A and 7B are views showing an operation of a load port.

FIGS. 8A and 8B are views showing an operation of a load port.

FIG. 9A is a view showing a layout of a scanner, and FIG. 9B is a view showing portions of end surfaces of wafers detected by a plurality of sensors respectively.

FIG. 10 is a flowchart showing an overall mapping process.

FIG. 11 is a flowchart showing a determination process for each wafer.

### DETAILED DESCRIPTION

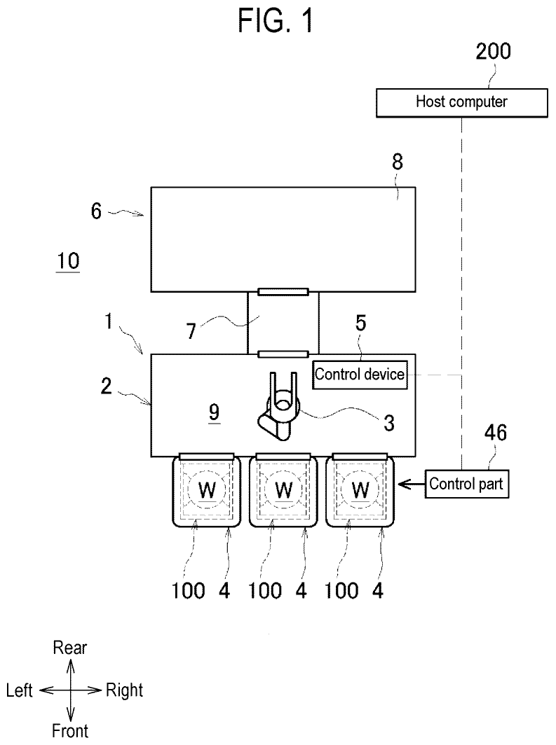

An embodiment of the present disclosure will be described. For the sake of convenience of description, directions shown in FIG. 1 are defined as front, rear, left, and right directions. More specifically, a direction in which an EFEM 1 (described later) and a processing apparatus 6 (described later) are arranged is defined as a front-rear direction. In the front-rear direction, a side near the EFEM 1 is defined as a front side. In the front-rear direction, a side near the processing apparatus 6 is defined as a rear side. A direction perpendicular to the front-rear direction, in which multiple load ports 4 are arranged, is defined as a left-right direction. A direction perpendicular to both the front-rear direction and the left-right direction is defined as an up-down direction. The up-down direction is a direction parallel to a vertical direction in which gravity acts.

### Schematic Configuration of Load Port and Its Surroundings

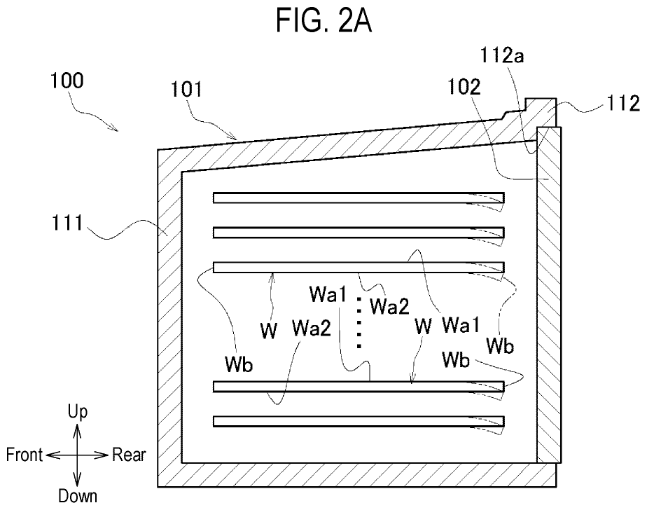

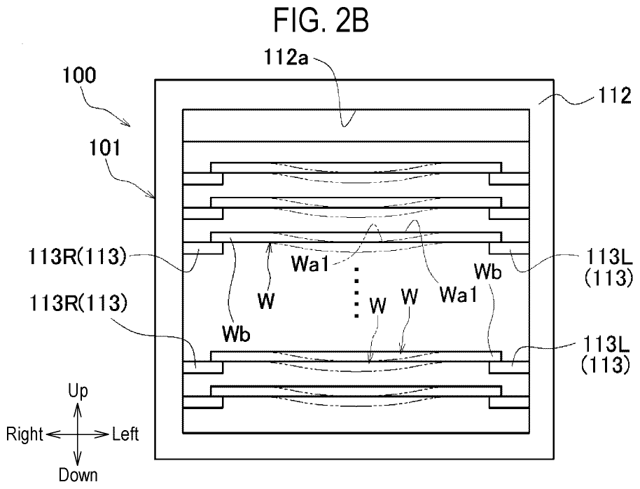

A schematic configuration of the load port 4 according to the present embodiment and its surroundings will be described with reference to FIG. 1. FIG. 1 is a schematic diagram of an EFEM 1 equipped with multiple load ports 4 and its surroundings. “EFEM” is an abbreviation for “Equipment Front End Module.” The EFEM 1 is a device configured to transfer a wafer W between a FOUP 100 (described below) mounted on each load port 4 and the processing apparatus 6. The wafer W is, for example, a substantially disc-shaped semiconductor substrate. A diameter of the wafer W accommodated in the FOUP 100 is, for example, approximately 300 mm. The wafer W has an upper surface Wa1, a lower surface Wa2, and an end surface Wb (see FIGS. 2A and 2B). The upper surface Wa1 is a surface facing substantially upward. The lower surface Wa2 is a surface facing substantially downward. The end surface Wb is a surface arranged between the upper surface Wa1 and the lower surface Wa2 in the up-down direction. In the present embodiment, the wafer W corresponds to the substrate of the present disclosure.

As shown in FIG. 1, the EFEM 1 includes a housing 2, a transfer robot 3, a plurality of load ports 4, and a control device 5. A processing apparatus 6 is arranged behind the EFEM 1.

The EFEM 1 is installed at a predetermined position in, for example, a semiconductor factory. The EFEM 1 transfers the wafer W between the FOUP 100 mounted on the load port 4 and the processing apparatus 6 by using a transfer robot 3 arranged in a transfer space 9 inside the housing 2. “FOUP” is an abbreviation for “Front-Opening Unified Pod.” The FOUP 100 is a container configured to be capable of accommodating a plurality of wafers W arranged in the up-down direction. The FOUP 100 is transferred by, for example, a FOUP transfer device (not shown). The FOUP 100 is transferred between the FOUP transfer device and the load port 4.

The housing 2 is a box-shaped member having a transfer space 9 in which the wafer W is transferred. The transfer space 9 is separated from an external space 10 mainly by the housing 2. The external space 10 is a space outside the EFEM 1 and the processing apparatus 6. A plurality of load ports 4 are connected to the front end of the housing 2. A load lock chamber 7 (described later) of the processing apparatus 6 is connected to the rear end of the housing 2. The transfer robot 3 is configured to be capable of transferring the wafer W between the FOUP 100 and the load lock chamber 7.

The load ports 4 are arranged, for example, side by side in the left-right direction. The load ports 4 are attached to the front end of the housing 2. Each load port 4 is configured such that the FOUP 100 is mounted thereon. Each load port 4 is configured to attach and detach a lid 102 (described below) to a FOUP body 101 (described below) of the FOUP 100. Each load port 4 is configured to be capable of performing mapping for the plurality of wafers W accommodated in the FOUP body 101. A configuration of the load port 4 will be described in more detail below.

The control device 5 is electrically connected to a control part (not shown) of the transfer robot 3, a control part 46 (described later) of the load port 4, and a control part (not shown) of the processing apparatus 6. The control device 5 is configured to communicate with these control parts. As shown in FIG. 1, the control device 5 may also be electrically connected to a higher-level host computer 200.

The processing apparatus 6 is an apparatus configured to perform a predetermined process on the wafer W. The predetermined process may be, for example, a process performed in a vacuum chamber (such as sputtering or dry etching), or may be other processes. As shown in FIG. 1, the processing apparatus 6 includes, for example, a load lock chamber 7 and a processing chamber 8. The load lock chamber 7 is a chamber in which the wafer Wis temporarily kept on standby. The load lock chamber 7 is arranged between the transfer space 9 and the processing chamber 8. The processing chamber 8 is a chamber in which the predetermined process is performed on the wafer W.

### FOUP

An example of the configuration of the FOUP 100 will be described with reference to FIGS. 2A and 2B. FIG. 2A is a side cross-sectional view of the FOUP 100. FIG. 2B is a rear view of the FOUP 100 with the lid 102 removed. The front, rear, left, and right directions shown in FIGS. 2A and 2B are directions for the sake of convenience of description when the FOUP 100 is placed on the load port 4.

The FOUP 100 is a container having a substantially rectangular parallelepiped shape. The FOUP 100 is configured to be capable of accommodating, for example, 25 wafers W. The number of wafers W that the FOUP 100 can accommodate is not limited thereto. As shown in FIGS. 2A and 2B, the FOUP 100 includes a FOUP body 101 and a lid 102. The FOUP body 101 is a substantially rectangular parallelepiped member. The FOUP body 101 has an outer wall portion 111, an opening portion 112, and a plurality of support portions 113 (see FIG. 2B). The outer wall portion 111 is arranged so as to surround an internal space of the FOUP 100. The opening portion 112 is arranged at a rear end portion of the FOUP body 101. The opening portion 112 has an opening 112a that has a substantially rectangular shape when viewed from the rear.

A plurality of support portions 113 are configured to support the plurality of wafers W in a substantially horizontal posture. Each of the plurality of support portions 113 is, for example, a substantially flat plate-shaped member. Each of the plurality of support portions 113 extends long in the front-rear direction. A thickness direction of each of the plurality of support portions 113 is substantially parallel to the up-down direction. Each left-right end of the wafer W is mounted on an upper surface of one of the support portions 113. As shown in FIG. 2B, the plurality of support portions 113 are arranged in a substantially rectangular parallelepiped space surrounded by the FOUP body 101. Each of the plurality of support portions 113 is fixed, for example, to an inner surface of one of both left-right ends of the outer wall portion 111. Hereinafter, for the sake of convenience of description, the plurality of support portions 113 fixed to an inner surface of the left end of the outer wall portion 111 will be referred to as a plurality of support portions 113L. The plurality of support portions 113L are arranged on a left side of a center of the FOUP 100 in the left-right direction. The plurality of support portions 113L are arranged side by side in the up-down direction. Each of the plurality of support portions 113L corresponds to a second support portion of the present disclosure.

Hereinafter, for the sake of convenience of description, among the plurality of support portions 113, the plurality of support portions 113 fixed to an inner surface of the right end of the outer wall portion 111 will be referred to as a plurality of support portions 113R. The plurality of support portions 113R are arranged on a right side of the center of the FOUP 100 in the left-right direction. The plurality of support portions 113R are arranged side by side in the up-down direction. Each of the plurality of support portions 113R corresponds to a first support portion of the present disclosure.

The number of the plurality of support portions 113L is the same as the number of the plurality of support portions 113R. That is, the plurality of support portions 113L and the plurality of support portions 113R are in a one-to-one correspondence. One support portion 113L and one support portion 113R corresponding to each other are arranged at approximately the same position in the up-down direction. Such a pair of support portion 113L and support portion 113R is arranged to support one wafer W. The space for supporting one wafer W is called a slot. That is, the FOUP 100 has a plurality of slots.

The lid 102 is configured to open and close the opening 112a. The lid 102 is attached to and detached from the FOUP body 101 by the load port 4, as will be described later.

### Wafer in FOUP

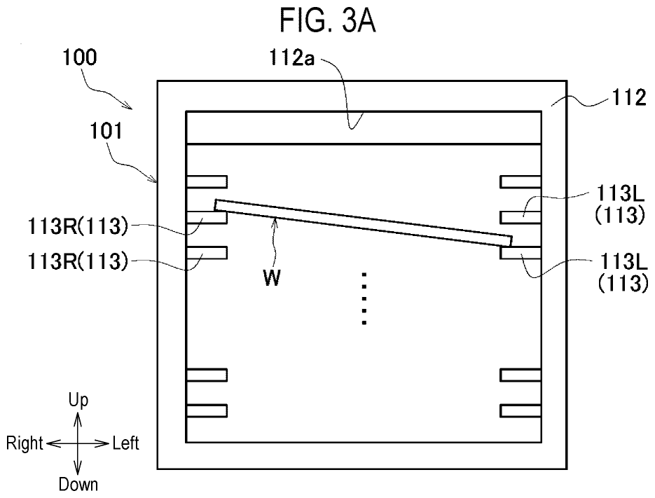

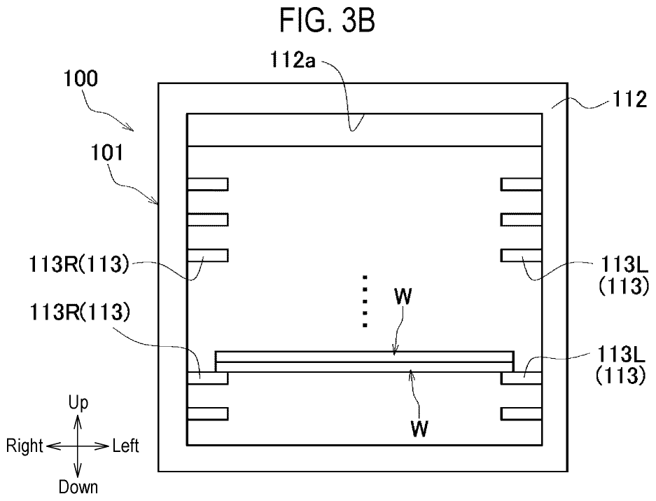

To aid in the following description, a state of the wafers W accommodated in the FOUP 100 will be briefly described with reference to FIGS. 2A to 3B. FIGS. 3A and 3B are views showing the wafers W accommodated in an abnormal state in the FOUP 100. FIG. 3A is a view showing the wafer W in a cross state, which will be described later. FIG. 3B is a view showing the wafer W in a double state, which will be described later. FIGS. 3A and 3B show only one or more wafers W accommodated in one of the plurality of slots.

When each wafer W is accommodated in the FOUP 100 in a normal state, as shown in FIG. 2B, the plurality of wafers W are placed on multiple pairs of support portions 113L and 113R respectively. This state of the wafers W is called a single state. On the other hand, the wafer W may be accommodated in the FOUP 100 in an abnormal state. For example, as shown in FIG. 3A, the wafer W may be placed on a certain support portion 113L and a support portion 113R located at a position offset in the up-down direction from the support portion 113L. This state of wafers W is called a cross state. Alternatively, for example, as shown in FIG. 3B, two wafers W may be accommodated in the same slot while overlapping in the up-down direction. This state of two wafers W is called a double state.

As indicated by the two-dot chain line in FIG. 2A and the two-dot chain line in FIG. 2B, each wafer W in the single state may be deflected. Details will be described later.

### Load Port

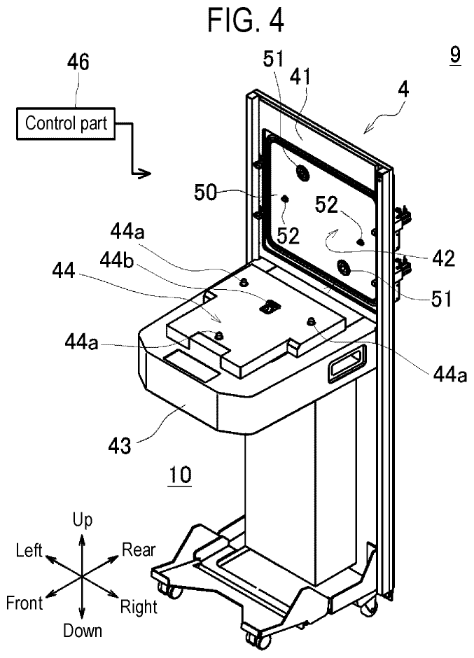

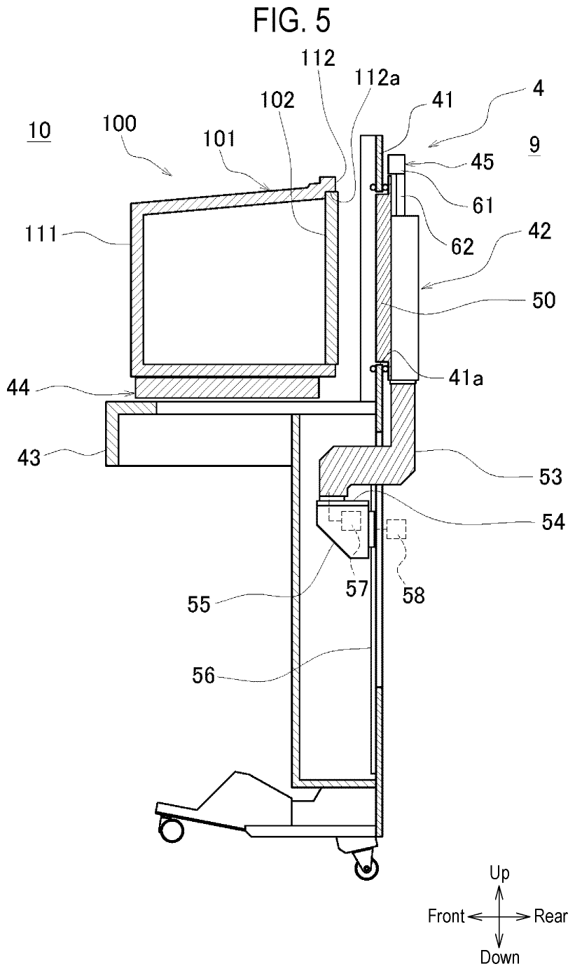

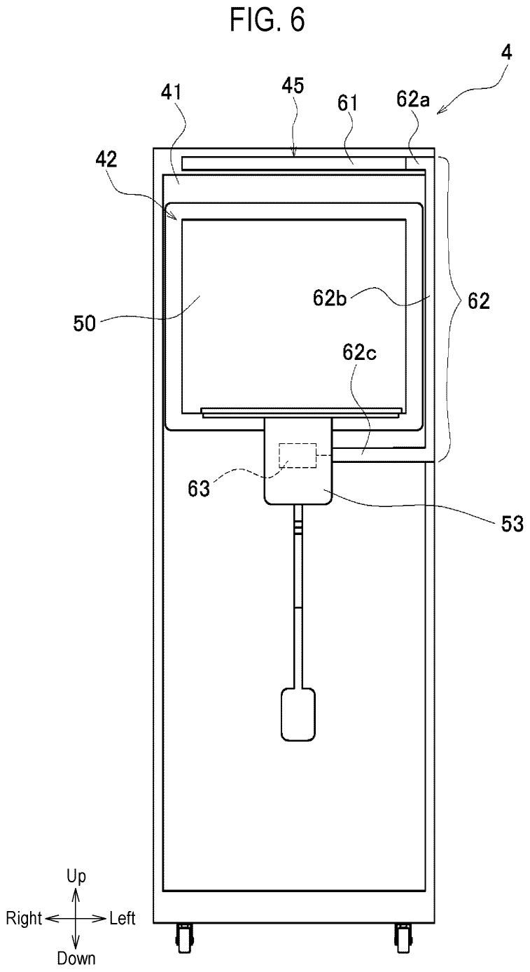

A configuration of the load port 4 will be described with reference to FIGS. 4 to 6. FIG. 4 is a perspective view of the load port 4. FIG. 5 is a right side view of the load port 4. FIG. 6 is a rear view of the load port 4.

The load port 4 is configured to remove the lid 102 of the FOUP 100 from the FOUP body 101 and perform mapping of the plurality of wafers W accommodated in the FOUP body 101. As shown in FIGS. 4 to 6, the load port 4 includes, for example, a base 41, a door mechanism 42, a support frame 43, a mounter 44, a scanner 45, and a control part 46.

The base 41 is a substantially flat member. The base 41 has a substantially rectangular shape when viewed from the front-to-rear direction. The base 41 is arranged to extend in the up-down direction. The base 41 is fixed to the EFEM 1. The base 41 is a part of a partition wall that separates the transfer space 9 from the external space 10. The base 41 has a substantially rectangular opening 41a. The opening 41a is arranged in an upper portion of the base 41. The opening 41a is large enough to allow the lid 102 of the FOUP 100 to pass through the opening 41a in the front-to-rear direction. The opening 41a is opened and closed by a door body 50, which will be described later.

The door mechanism 42 is configured to enable the lid 102 to be attached to and detached from the FOUP body 101. As shown in FIGS. 4 and 5, the door mechanism 42 includes, for example, a door body 50, a plurality of suction holding portions 51, a plurality of latch keys 52, a door support portion 53, a guide rail 54, a lifting block 55, a guide rail 56, a motor 57, and a motor 58.

The door body 50 is a plate-shaped member. When viewed from the front-rear direction, the door body 50 has a substantially rectangular shape. The door body 50 is supported by the door support portion 53. The plurality of suction holding portions 51 are configured to suck and hold the lid 102 on the front surface of the door body 50. The plurality of suction holding portions 51 are connected to a vacuum pump (not shown). When the vacuum pump operates, a negative pressure is generated inside a pip, and the lid 102 is sucked and held on the door body 50. The latch key 52 is configured to unlock and lock the lid 102 of the FOUP 100. The latch key 52 has such a size and shape that it can be inserted into a keyhole (not shown) of the lid 102. The latch key 52 is driven by an opening/closing mechanism (not shown) to unlock or lock the lid 102 attached to the FOUP body 101.

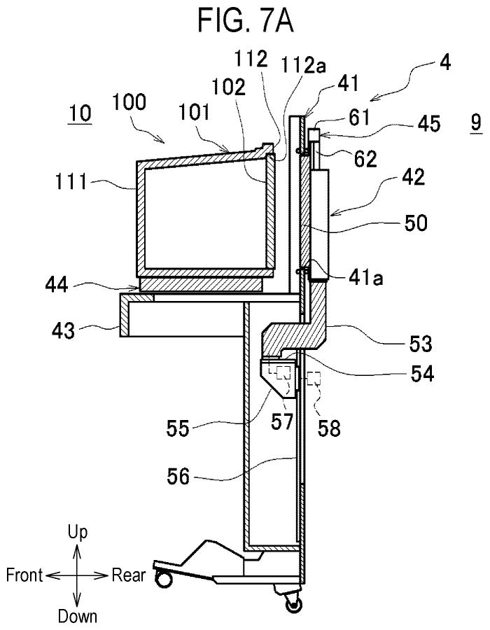

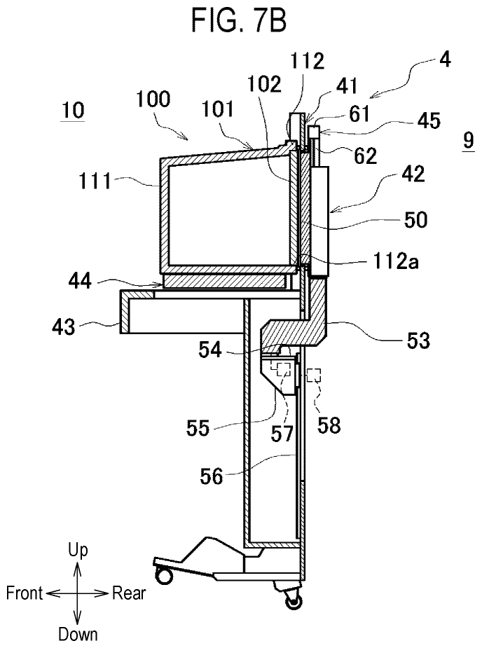

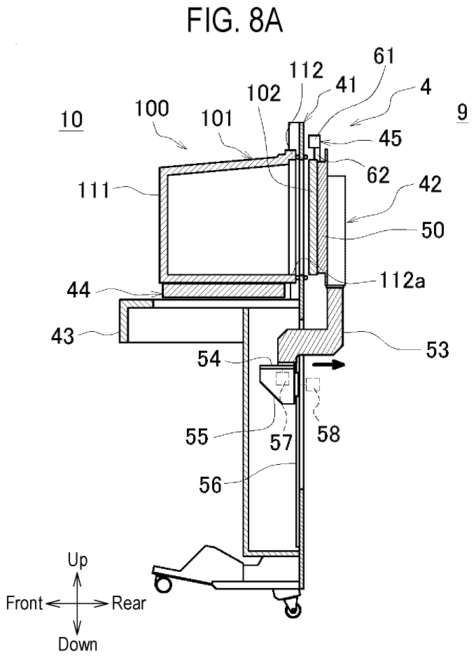

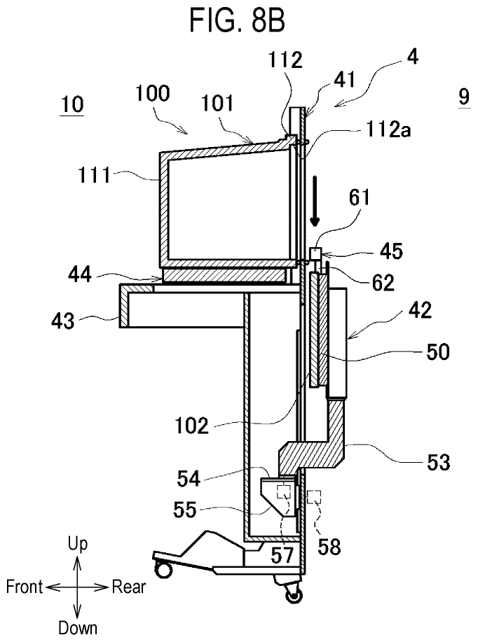

The door support portion 53 is a member configured to support the door body 50. The door support portion 53 is arranged outside a movable range of the transfer robot 3 in the transfer space 9. The door body 50 is fixed to the door support portion 53 by a fixing member (not shown). The door support portion 53 extends in the up-down direction. The door support portion 53 is supported by the guide rail 54 so as to be movable in the front-rear direction. The door support portion 53 is driven to move in the front-rear direction by the motor 57. The door support portion 53 moves in the front-rear direction to move the door body 50 between a closed position (see FIG. 7B) and an open position (see FIG. 8A). The closed position is a position of the door body 50 at which the door body 50 blocks the opening 41a of the base 41. The open position is a position rearward of the closed position and is a position of the door body 50 at which the door body 50 opens the opening 41a. The guide rail 54 is a member configured to guide the door support portion 53 in the front-rear direction. The guide rail 54 is provided on the lifting block 55. The guide rail 54 extends in the front-rear direction.

The lifting block 55 is a member configured to move the door main body 50 in the up-down direction. The lifting block 55 movably supports the door support portion 53 by the guide rail 54. The lifting block 55 is guided in the up-down direction along the guide rail 56. The lifting block 55 is driven to move in the up-down direction by the motor 58. By moving the lifting block 55 in the up-down direction, the door body 50 is moved between the above-mentioned open position (see FIG. 8A) and a retracted position (see FIG. 8B) that is lower than the open position. The guide rail 56 is a member configured to guide the lifting block 55 in the up-down direction. The guide rail 56 is attached to, for example, the base 41. The guide rail 56 extends in the up-down direction.

The motor 57 is configured to drive the door support portion 53 to move in the front-rear direction. The motor 57 is, for example, a known stepping motor driven by a pulse signal. The motor 57 is configured to be capable of controlling the position of the door support portion 53 in the front-rear direction. The motor 58 is configured to drive the lifting block 55 to move in the up-down direction. The motor 58 is, for example, a known stepping motor driven by a pulse signal. The motor 58 is configured to be capable of controlling the position of the door support portion 53 in the up-down direction. In other words, the motor 58 is also configured to be capable of controlling a position of a below-described detection part 61 (see FIG. 5, etc.) in the up-down direction.

The support frame 43 is a member configured to support the mounter 44. The support frame 43 has a substantially rectangular shape when viewed from the up-down direction. The support frame 43 is fixed to the base 41. That is, an installation position of the support frame 43 is fixed. The support frame 43 is arranged so as to protrude forward from a midpoint of the base 41 in the up-down direction. The support frame 43 corresponds to the base of the present disclosure.

The mounter 44 is a table-like member on which the FOUP 100 is mounted. The mounter 44 is supported by the support frame 43. The mounter 44 is configured to be movable with respect to the support frame 43 in the front-rear direction. The mounter 44 has positioning pins 44a and a locking claw 44b. The positioning pins 44a are members configured to position the FOUP 100. The locking claw 44b is a member configured to fix and release the FOUP 100 with respect to the mounter 44. The mounter 44 is configured to be movable by a drive mechanism (not shown) between a predetermined delivery position and a lid opening/closing position behind the delivery position. The delivery position is the position of the mounter 44 at which the FOUP 100 can be transferred to and from a FOUP transfer device (not shown). The mounter 44 may also be configured to be rotatable about a vertical axis.

The scanner 45 is configured to detect a plurality of wafers W. The scanner 45 is arranged, for example, in the transfer space 9. As shown in FIG. 6, the scanner 45 includes a detection part 61, a support member 62, and a front-rear driver 63.

The detection part 61 is configured to detect a plurality of wafers W. The detection part 61 is arranged, for example, above the door body 50. The detection part 61 is supported by the support member 62. The detection part 61 is movable between a predetermined standby position (see FIGS. 7A and 7B) and a scan position (see FIG. 8A) by the front-rear driver 63. The scan position is, for example, a position where at least a part of the detection part 61 protrudes forward from the door body 50. A structure of the detection part 61 will be described in more detail below.

The support member 62 is a member configured to support the detection part 61. As shown in FIG. 6, the support member 62 is a member having a substantially C-like shape when viewed from the front-rear direction. The support member 62 has, for example, an upper end portion 62a to which the detection part 61 is fixed, an extension portion 62b extending downward from the left end of the upper end portion 62a, and a lower end portion 62c extending rightward from the lower end of the extension portion. In the present embodiment, the support member 62 is opened to the right side. However, the present disclosure is not limited thereto. The support member 62 may be opened to the left side. The support member 62 is arranged, for example, so as to bypass the door body 50. The lower end portion 62c of the support member 62 may be swingably supported, for example, by the door support portion 53. A swing axis direction of the support member 62 may be, for example, substantially parallel to the left-right direction. The support member 62 may be swingably driven, for example, by a front-rear driver 63.

The front-rear driver 63 is configured to drive the detection part 61 to move in the front-rear direction. The front-rear driver 63 may include, for example, a motor (not shown). Alternatively, the front-rear driver 63 may include, for example, an air cylinder (not shown). The front-rear driver 63 may drive the support member 62 to swing, for example, to move the detection part 61 in the front-rear direction. The front-rear driver 63 is electrically connected to the control part 46.

The control part 46 includes a CPU, a ROM, and a RAM (which are not shown). The control part 46 controls each mechanism of the load port 4 by the CPU in accordance with a program stored in the ROM. The control part 46 also communicates with the control device 5 of the EFEM 1, the host computer 200, etc. The control part 46 corresponds to the determiner of the present disclosure.

Additionally, the load port 4 may include a replacement part (not shown) configured to replace the gas inside the FOUP 100. The load port 4 may include a clamping mechanism (not shown) configured to press the FOUP body 101 against the base 41. Details thereof will not be described.

### Basic Operation of Load Port

A basic operation of the load port 4 having the above configuration will be described with reference to FIGS. 7A to 8B. FIGS. 7A to 8B are right side views of the load port 4 in operation. Now, an operation of the load port 4 from when the FOUP 100 is mounted on the mounter 44 to when the plurality of wafers W are detected at least once by the scanner 45 will be described.

First, the FOUP 100 is mounted on the mounter 44 (see FIG. 7A). The FOUP 100 is positioned by the positioning pins 44a and secured to the mounter 44 by the locking claw 44b. Next, the control part 46 moves the mounter 44 from the delivery position (see FIG. 7A) to the lid opening/closing position (FIG. 7B). This causes the plurality of latch keys 52 (see FIG. 4) to relatively approach the FOUP 100 and to be inserted into the plurality of keyholes formed in the lid 102 respectively. When the mounter 44 is at the lid opening/closing position, it neither moves nor rotates. In other words, the angle of the FOUP 100 about the vertical axis with respect to the support frame 43 is kept fixed. For ease of description, this state of the FOUP 100 will be referred to as a fixed state. When the FOUP 100 is in the fixed state, a width direction of the opening 112a (a container width direction of the present disclosure) is approximately parallel to the left-right direction. The right side corresponds to one side in the container width direction of the present disclosure. The left side corresponds to the other side in the container width direction of the present disclosure.

After the FOUP 100 is mounted on the mounter 44, the control part 46 may control the replacement part (not shown) to perform a purge process to replace the gas inside the FOUP 100. The control part 46 may control a clamping mechanism (not shown) to press a rear end surface of the FOUP body 101 against the base 41.

Next, the control part 46 controls a vacuum pump (not shown) to suck and hold the lid 102 to the suction holding portion 51 of the door body 50. The control part 46 controls the operation of the latch keys 52 to unlock the lid 102. The control part 46 controls the motor 57 to move the door support portion 53 rearward (see the rightward arrow in FIG. 8A). This moves the door body 50 from the predetermined closed position (see FIG. 7B) to the open position (see FIG. 8A). As a result, the lid 102 is removed from the FOUP body 101.

Next, the control part 46 controls the front-rear driver 63 to move the detection part 61 from the standby position (see FIG. 7B) to the scan position (see FIG. 8A). This operation is a preparatory operation for the detection part 61 to detect a plurality of wafers W.

Next, the control part 46 controls the motor 58 to move the door body 50 from the open position (see FIG. 8A) to the retracted position (see FIG. 8B). This enables the detection part 61 to detect the plurality of wafers W arranged in the up-down direction sequentially from the top. The control part 46 performs a mapping process based on the position information for the plurality of wafers W detected by the detection part 61. In the present embodiment, the mapping process is a process that includes determining whether the plurality of wafers W are normally accommodated in the FOUP body 101. The mapping process will be described in detail later.

After the mapping process is completed, the transfer robot 3 starts transferring the wafers W between the FOUP 100 and the processing apparatus 6. The processing apparatus 6 sequentially performs predetermined processes on some or all of the wafers W. The processed wafers W are returned into the FOUP 100 by the transfer robot 3.

After all the wafers W have been returned into the FOUP 100, the control part 46 causes the door mechanism 42 and the like to perform an operation reverse to the operation performed when opening the lid 102. That is, the control part 46 moves the door body 50 from the retracted position to the open position, and then from the open position to the closed position.

Next, the control part 46 controls the operation of the latch keys 52 to lock the lid 102. The control part 46 releases the suction of the lid 102 to the door body 50. Thereafter, the control part 46 moves the mounter 44 from the lid opening/closing position to the delivery position. In this manner, a series of processes from when the FOUP 100 is transferred to the load port 4 to when the FOUP 100 is ready for unloading is completed.

### Wafer Deflection

Recently, wafers W have been made thinner. In the related art, a thickness of a wafer W is, for example, 0.775 mm. In recent years, there has been a trend that wafers W become very thin, with a thickness of 0.1 mm to 0.2 mm. As a result, deflection of a wafer W, mainly due to its own weight, has become more apparent. Examples of a deflection pattern of the wafer W include the following two patterns. In a first pattern, as indicated by the two-dot chain line in FIG. 2A, a rear end portion of the wafer W may sag. In a second pattern, as indicated by the two-dot chain line in FIG. 2B, the entire central portion of the wafer W in the left-right direction may sag. In either pattern, it is understood that the portion of the wafer W that is not supported by the support portion 113 is deflected due to its own weight.

In view of the above, there is a need to calculate the amount of deflection of the wafer W during the mapping process in the load port 4. For example, Japanese Utility Model Registration No. 3177757 describes a device configured to calculate an amount of deflection of a substrate (not shown) in a container (not shown). However, this device requires that an angular position of the container about the vertical axis be changed during the mapping process. In the load port 4, when the mounter 44 is at the lid opening/closing position (see FIG. 7B), even in a case where an attempt is made to rotate the mounter 44 during the mapping process, the FOUP 100 will interfere with the base 41. Therefore, in the present embodiment, the load port 4 has the following configuration to measure the amount of deflection of the wafer W in the FOUP 100 without rotating the FOUP 100. More specifically, the scanner 45 has the following configuration.

### Detailed Configuration of Scanner

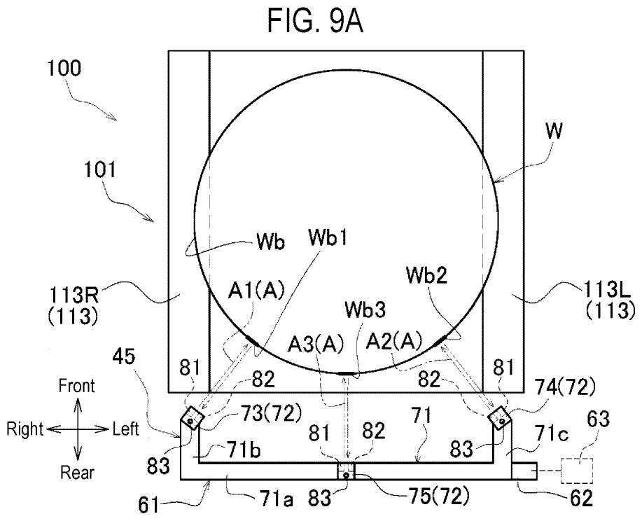

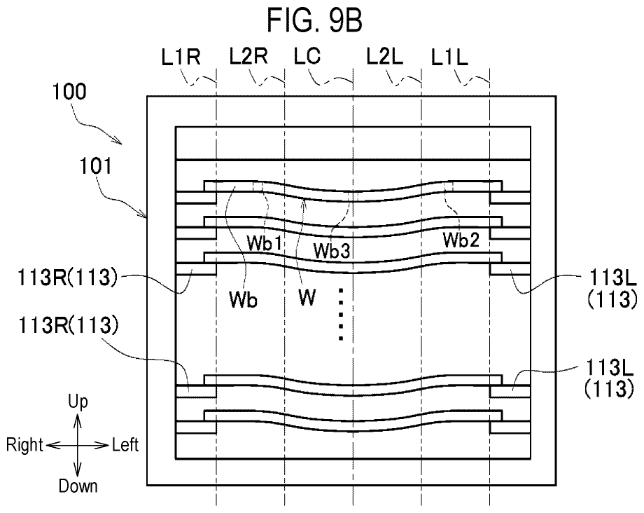

The detailed configuration of the scanner 45 will be described with reference to FIGS. 9A and 9B. FIG. 9A is a plan view schematically showing an arrangement of the scanner 45. FIG. 9B is a diagram showing portions of the end surface Wb of the wafer W that are respectively detected by a plurality of sensors 72 described below. The directions shown in FIG. 9B are the same as those shown in FIG. 2B. The left-right direction in the present embodiment is opposite to the left-right direction on the paper in FIGS. 9A and 9B.

As described above, the scanner 45 includes the detection part 61, the support member 62, and the front-rear driver 63. As shown in FIG. 9A, the detection part 61 includes, for example, a main body 71 and three sensors 72.

The main body 71 is a member to which the three sensors 72 are attached. The main body 71 is, for example, a substantially rod-shaped member. The main body 71 extends, for example, in a direction substantially parallel to the left-right direction. The main body 71 supports the three sensors 72. The main body 71 corresponds to the support portion of the present disclosure. For example, the left end of the main body 71 is fixed to the support member 62 by, for example, a fixing member (not shown). Alternatively, the main body 71 and the support member 62 may be fixed to each other by a different means or may be constituted by the same member.

As shown in FIG. 9A, the main body 71 has, for example, an elongated portion 71a, a protrusion portion 71b, and a protrusion portion 71c. The elongated portion 71a is, for example, a substantially rod-shaped portion. The elongated portion 71a extends, for example, in a direction substantially parallel to the left-right direction. The elongated portion 71a is arranged behind the FOUP 100 on the mounter 44. In the left-right direction, a center position of the elongated portion 71a is substantially equal to a center position of the mounter 44 (i.e., a center position of the FOUP 100 on the mounter 44). The protrusion portion 71b is, for example, a substantially rod-shaped portion. The protrusion portion 71b is shorter than the elongated portion 71a. The protrusion portion 71b protrudes forward, for example, from the right end of the elongated portion 71a. The protrusion portion 71c is, for example, a substantially rod-shaped portion. The protrusion portion 71c has a length substantially equal to that of the protrusion portion 71b in the front-rear direction. The protrusion portion 71c protrudes forward from, for example, the left end of the elongated portion 71a.

Each of the three sensors 72 is configured to be capable of detecting the end surface Wb of the wafer W. Each sensor 72 is, for example, a known reflective laser sensor. That is, each sensor 72 is configured to be capable of emitting and detecting, as detection light, a laser beam for detecting the end surface Wb. The reflective laser sensor corresponds to a reflective optical sensor of the present disclosure. It is preferable that the three sensors 72 are arranged at approximately equal positions in the up-down direction.

Each sensor 72 includes a light emitter 81 and a light receiver 82. The light emitter 81 includes a light emitting element (not shown) capable of emitting laser light (see the two-dot chain line arrow in FIG. 9A). The light emitter 81 is arranged to emit the laser light in a direction that is substantially horizontal and perpendicular to the end surface Wb. In other words, an optical axis A of the light emitter 81 is arranged substantially horizontally. Furter, the optical axis A of the light emitter 81 is also arranged to be substantially perpendicular to a portion of the end surface Wb of the wafer W in the FOUP 100. A shape of the laser beam may be, for example, substantially circular. Alternatively, the shape of the beam may be a shape other than the substantially circular shape, such as an elliptical shape or a substantially rectangular shape. A length of the beam in the up-down direction is preferably smaller than, for example, the thickness of the wafer W (i.e., a designed length of the end surface Wb in the up-down direction). The light receiver 82 includes a light receiving element (not shown) capable of detecting the laser light (see the two-dot chain line arrow in FIG. 9A). The light receiver 82 is arranged so as to sense the laser light reflected by the end surface Wb.

The scanner 45 preferably includes a plurality of angle regulators 83. The angle regulators 83 are configured to independently regulate the angles of the optical axes A of the sensors 72 about the vertical axis. Each angle regulator 83 may include, for example, a screw (not shown) to fix the sensor 72 to the main body 71. The angle of the sensor 72 about the vertical axis may be changeable when the screw is loosened, and the sensor 72 may be fixed to the main body 71 by tightening the screw. Alternatively, the angle regulator 83 may include, for example, a rotary shaft (not shown), a gear (not shown), and a knob (not shown). The rotary shaft may support the sensor 72 rotatably about the vertical axis. The gear may be coaxial with the rotary shaft and fixed to the rotary shaft. The knob may include a member configured to engage with the gear. The knob may be configured to be turned by an operator. Rotating the knob may gradually rotate the sensor 72 about the vertical axis via the gear. Alternatively, the angle regulator 83 may include a motor (not shown) including a rotary shaft instead of a knob, for example. This allows the angle of the optical axis A about the vertical axis to be regulated by the operation of the motor. Alternatively, the scanner 45 may include any angle regulator 83 configured to be capable of regulating the angle of the optical axis A of each sensor 72 about the vertical axis.

An example of arrangement positions of the three sensors 72 will be described. It is assumed that the mounter 44 on which the FOUP is mounted is at the lid opening/closing position (see FIG. 7B). As indicated by the one-dot chain line in FIG. 9B, when viewed from the front-rear direction, an imaginary line extending in the up-down direction through the center of the FOUP 100 in the left-right direction is defined as an imaginary center line LC. As indicated by the two-dot chain line in FIG. 9B, an imaginary line extending in the up-down direction through the left ends of the plurality of support portions 113R is defined as a first right straight line L1R. An imaginary line extending in the up-down direction through the right ends of the plurality of support portions 113L is defined as a first left straight LIL. An imaginary line extending in the up-down direction through a position exactly midway between the imaginary center line LC and the first right straight line LIR in the left-right direction is defined as a second right straight line L2R. An imaginary line extending in the up-down direction through a position exactly midway between the imaginary center line LC and the first left straight line LIL in the left-right direction is defined as a second left straight line L2L.

As shown in FIG. 9A, the three sensors 72 include a first sensor 73, a second sensor 74, and a third sensor 75. The first sensor 73 is attached to, for example, the front end of the protrusion portion 71b. The optical axis Al as the optical axis A of the first sensor 73 is arranged so as to be substantially perpendicular to a first portion Wb1 (see FIGS. 9A and 9B), which is a portion of the end surface Wb of the wafer W. The first portion Wb1 is located on the rear of the center of the wafer W in the front-rear direction. The position of the first portion Wb1 will be described in more detail below.

The second sensor 74 is attached to, for example, the front end of the protrusion portion 71c. The optical axis A2 as the optical axis A of the second sensor 74 is arranged so as to be substantially perpendicular to the second portion Wb2 (see FIGS. 9A and 9B). The second portion Wb2 is a portion of the end surface Wb of the wafer W and is different from the first portion Wb1. The second portion Wb2 is located on the rear of the center of the wafer W in the front-rear direction. The second portion Wb2 is arranged at a position separated from the first portion Wb1 in the extension direction of the end surface Wb (in the present embodiment, the circumferential direction of the wafer W). The position of the second portion Wb2 will be described in more detail below.

The third sensor 75 is attached, for example, to the center of the elongated portion 71a in the left-right direction. In other words, the third sensor 75 is arranged at a position approximately at the center between the protrusion portions 71b and 71c in the left-right direction. The optical axis A3 as the optical axis A of the third sensor 75 is arranged so as to be approximately perpendicular to the third portion Wb3 (see FIGS. 9A and 9B). The third portion Wb3 is a portion of the end surface Wb of the wafer W and is different from both the first portion Wb1 and the second portion Wb2. The third portion Wb3 is located at the rear end of the wafer W. The third portion Wb3 is arranged at a position separated from both the first portion Wb1 and the second portion Wb2 in the extension direction of the end surface Wb. The position of the third portion Wb3 will be described in more detail below.

The positions of the first portion Wb1, the second portion Wb2, and the third portion Wb3 in the left-right direction will be described in more detail. As shown in FIG. 9B, the first portion Wb1 is located to the right of the imaginary center line LC. It is preferable that the first portion Wb1 be located to the left of the first right straight line LIR (i.e., on the inside in the left-right direction). It is even more preferable that the first portion Wb1 be located between the first right straight line L1R and the second right straight line L2R in the left-right direction. In other words, the first portion Wb1 is located near the support portion 113R in the left-right direction. Therefore, the first portion Wb1 is a portion of the end surface Wb of the wafer W that is less likely to be deflected. The second portion Wb2 is located to the left of the imaginary center line LC. More specifically, it is preferable that the second portion Wb2 be located to the right of the first left straight line LIL (i.e., on the inside in the left-right direction). It is more preferable that the second portion Wb2 be arranged between the first left straight line LIL and the second left straight line L2L in the left-right direction. That is, the second portion Wb2 is arranged near the support portion 113L in the left-right direction. Therefore, just like the first portion Wb1, the second portion Wb2 is a portion of the end surface Wb of the wafer W that is less likely to be deflected. The third portion Wb3 is arranged, for example, between the second right straight line L2R and the second left straight line L2L in the left-right direction. It is more preferable that the third portion Wb3 be arranged, for example, on the imaginary center line LC. That is, the third portion Wb3 is arranged farther from both the support portion 113R and the support portion 113L in the left-right direction. Therefore, the third portion Wb3 is a portion of the end surface Wb of the wafer W that is more likely to sag under its own weight than the first portion Wb1 and the second portion Wb2.

### Mapping Process

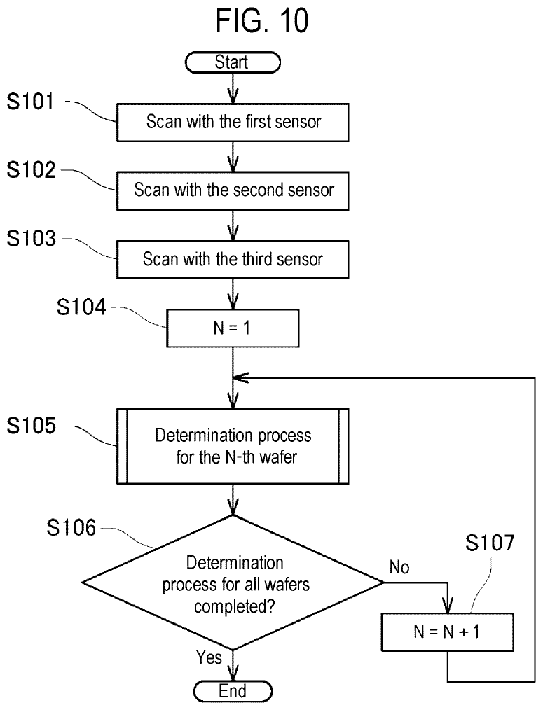

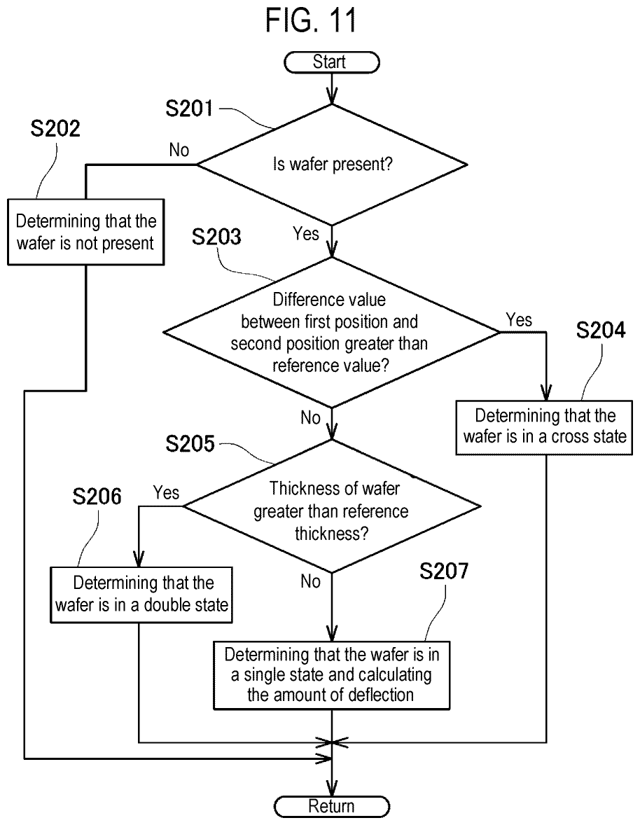

Next, the mapping process in the load port 4 described above will be described mainly with reference to FIGS. 10 and 11. FIG. 10 is a flowchart showing the overall mapping process. FIG. 11 is a flowchart showing the determination process for each wafer W.

An initial state is as follows. The FOUP 100 accommodating a plurality of wafers W is mounted on the mounter 44. The mounter 44 is located at the lid opening/closing position. The lid 102 of the FOUP 100 is opened by the door mechanism 42. The door body 50 is located at the open position (see FIG. 8A). The detection part 61 is located at the scan position (see FIG. 8A).

First, the control part 46 executes a scan with the first sensor 73 (step S101 shown in FIG. 10). More specifically, the control part 46 controls the motor 58 to move the door support portion 53 and the detection part 61 together in the up-down direction. The control part 46 moves the detection part 61, for example, from a predetermined upper end position to a predetermined lower end position. For example, a length of each step in the up-down direction (step length) taken by the detection part 61 during its movement is preferably shorter than a length of the optical axis A of each sensor 72 in the up-down direction. The control part 46 calculates position information of the detection part 61 in the up-down direction by using information on the step length and information on the number of pulse signals sent to the motor 58. When the first sensor 73 detects the detection light, it sends a detection signal indicating that the first portion Wb1 has been detected to the control part 46. The control part 46 stores the position information of the detection part 61 in the up-down direction and the information on the detection signal from the first sensor 73 in association with each other.

After completing the scan with the first sensor 73, the control part 46 executes a scan with the second sensor 74 (step S102). The control part 46 controls, for example, the motor 58 to return the detection part 61 to the upper end position and then move the detection part 61 back to the lower end position. When the second sensor 74 senses the detection light, it sends a detection signal indicating that the second portion Wb2 has been detected to the control part 46. The control part 46 stores the information about the position information of the detection part 61 in the up-down direction and the information about the detection signal from the second sensor 74 in association with each other. Alternatively, when returning the detection part 61 from the lower end position to the upper end position, the control part 46 may also store the information about the position information of the detection part 61 in the up-down direction and the information about the detection signal from the second sensor 74 in association with each other.

After completing the scan with the second sensor 74, the control part 46 executes a scan with the third sensor 75 (step S103). The control part 46 moves the detection part 61 as in steps S101 and S102. When the third sensor 75 senses the detection light, it sends a detection signal indicating that the third portion Wb3 has been detected to the control part 46. The control part 46 stores the information about the position information of the detection part 61 in the up-down direction and the information about the detection signal from the third sensor 75 in association with each other.

Next, the control part 46 sequentially performs a determination process (details of which will be described later), including a process for calculating the amount of deflection, for each wafer W. More specifically, the control part 46 inputs, for example, 1 into a predetermined variable N (step S104) and performs a determination process for the wafer W accommodated in the first slot (step S105). The control part 46 determines whether the determination process for all wafers W has been completed (step S106). In a case where there is a wafer W for which the determination process has not yet been performed (step S106: No), the control part 46 adds, for example, 1 to the variable N (step S107). As a result, the control part 46 performs a determination process for the wafer W (i.e., the wafer W associated with the N-th slot) next to the wafer W for which the determination process was previously completed (step S105). After the determination process for all wafers W has been completed (step S106: Yes), the control part 46 terminates the mapping process.

While the mapping process is being performed, the mounter 44 does not move or rotate. That is, the fixed state described above is maintained while the mapping process is being performed. While the fixed state is maintained, the scanner 45 detects the first portion Wb1, the second portion Wb2, and the third portion Wb3 of each of the plurality of wafers W.

### Determination Process

The determination process for each wafer W will be described with reference to FIG. 11. In summary, the control part 46 determines whether the wafer W to be determined (the wafer W associated with the N-th slot described above) is normally accommodated within the FOUP 100, and then calculates the amount of deflection of that wafer W.

First, the control part 46 determines whether or not the wafer W to be determined is present (step S201 shown in FIG. 11). More specifically, the control part 46 calculates, for example, the center position of the first portion Wb1 of the wafer W in the up-down direction based on the position information of the detection part 61 in the up-down direction and the detection signal from the first sensor 73. For the convenience of description, this center position is referred to as a first position. The control part 46 also calculates the center position of the second portion Wb2 of the wafer W in the up-down direction based on the position information of the detection part 61 in the up-down direction and the detection signal from the second sensor 74. For the convenience of description, this center position is referred to as a second position. The control part 46 determines, for example, whether at least one of the first position or the second position of the wafer W falls within a predetermined set range. The predetermined set range is a range of the position in the up-down direction corresponding to the wafer W to be determined. For example, upper and lower limit values of this set range are input in advance to the control part 46 or another computer device when the load port 4 is set up. Alternatively, the upper and lower limits may be stored in the control part 46 or another computer device in advance, for example, by predetermined teaching. When at least one of the first position or the second position of the wafer W falls within the set range, the control part 46 determines that the wafer W to be determined is present (step S201: Yes) and proceeds to the next step. On the other hand, when a wafer W is not accommodated in the N-th slot, neither the first portion Wb1 nor the second portion Wb2 is detected within the set range. When neither the first position nor the second position falls within the set range, the control part 46 determines that the wafer W associated with the N-th slot is not present (step S201: No). In this case, the control part 46 determines that a “substrate is not present” (step S202). When it is determined that a “substrate is not present.” the control part 46 terminates the determination process for the wafer W.

The definitions of the first position and the second position may be different from those described above. For example, the control part 46 may regard the position where the upper end of the first portion Wb1 is detected as the first position, and may regard the position where the upper end of the second portion Wb2 is detected as the second position. Alternatively, the control part 46 may regard the position where the lower end of the first portion Wb1 is detected as the first position, and may regard the position where the lower end of the second portion Wb2 is detected as the second position. The above set range is required to be set in advance in accordance with the definitions of the first position and the second position.

In the next step, the control part 46 determines whether the wafer W to be determined is in a cross state. The control part 46 determines whether a difference value (absolute value) between the first position and the second position of the wafer W is greater than a predetermined reference value (step S203). The reference value is a threshold value for determining whether the wafer W is accommodated in the FOUP 100 in an inclined state. The reference value is input to the control part 46 or another computer device in advance when the load port 4 is set up. Alternatively, the reference value may be stored in the control part 46 or another computer device in advance, for example, by predetermined teaching. The reference value may be, for example, half the value of a pitch of the plurality of slots in the FOUP 100 in the up-down direction. In a case where the difference value is greater than the reference value (step S203: Yes), the control part 46 performs a cross determination to determine that the state of the wafer W is in a cross state (step S204). After the cross determination is performed, the control part 46 terminates the determination process for the wafer W.

In a case where the difference value is equal to or less than the reference value (step S203: No), the control part 46 then determines whether the wafer W is in a double state. More specifically, the control part 46 acquires information about the length of the wafer W (i.e., the thickness of the wafer W) in the up-down direction based on the number of times the wafer W is detected by the detection part 61 during the scan by one or more sensors 72. The control part 46 may, for example, use information about the length of the first portion Wb1 in the up-down direction as information about the thickness of the wafer W. The control part 46 uses this information to determine whether the thickness of the wafer W is greater than a predetermined reference thickness (step S205). The reference thickness is a threshold value for determining whether two or more wafers W are accommodated in the same slot of the FOUP 100. In the same manner as the reference value, a value of the reference thickness is also stored in the control part 46 or another computer device in advance. The reference thickness may be, for example, 1.5 times a specified thickness of the wafer W. The reference thickness is not limited thereto. In a case where the thickness of the wafer W is greater than the reference thickness (step S205: Yes), the control part 46 performs a double determination to determine that the state of the wafer W is a double state (step S206). After the double determination is performed, the control part 46 terminates the determination process for the wafer W.

In a case where the thickness of the wafer W is equal to or less than the reference thickness (step S205: No), the control part 46 performs a single determination (step S207). The single determination is a determination which indicates that the wafer W is normally accommodated in the FOUP 100 and is in a single state. Furthermore, the control part 46 calculates the amount of deflection of the wafer W (step S207). More specifically, the control part 46 calculates the center position of the third portion Wb3 of the wafer W in the up-down direction based on the position information of the detection part 61 in the up-down direction and the detection signal from the third sensor 75. For the convenience of description, this center position is referred to as a third position. The control part 46 uses (i) information on the first position, information on the second position, or both of the information on the first position and the information on the second position of the wafer W, and (ii) information on the third position. For example, the control part 46 calculates the amount of deflection of the wafer W by subtracting a value of the third position from an average value of values of the first position and the second position. Alternatively, the control part 46 may calculate the value, which is obtained by subtracting the value of the third position from the value of the first position (or the value of the second position), as the amount of deflection of the wafer W. In this manner, the determination process for the wafer W is completed.

As described above, while the angle of the FOUP 100 with respect to the support frame 43 is fixed, the scanner 45 can detect the positions of the first portion Wb1, the second portion Wb2, and the third portion Wb3 of the end surface Wb of each wafer W in the up-down direction. Then, the control part 46 can determine whether each wafer W is normally accommodated in the FOUP 100. Furthermore, the control part 46 can calculate the amount of deflection of the wafer W normally accommodated in the FOUP 100. Therefore, it is possible to determine whether the wafer W is normally accommodated in the FOUP 100 and to calculate the amount of deflection of the wafer W without rotating the FOUP 100.

Furthermore, the first portion Wb1, which is located relatively close to the support portion 113R, and the second portion Wb2, which is located relatively close to the support portion 113L, are hardly deflected. The first portion Wb1 and the second portion Wb2 may be considered to be substantially undeflected. Accordingly, by using the information on the first position information and the information of the second position, it is possible to accurately determine whether each wafer W is located at the normal position within the FOUP 100. Furthermore, since the portions located relatively far from the support portions 113R and 113L in the left-right direction are more likely to be deflected due to their own weight, the third portion Wb3 is likely to be deflected more than the first portion Wb1 and the second portion Wb2. Accordingly, by using the information on the third position, and the information on the first position, the information on the second position, or both of the information on the first position and the information on the second position, it is possible to accurately calculate the amount of deflection of each wafer W.

Furthermore, each sensor 72 can regulate the angle of the optical axis A of the detection light about the vertical axis by the angle regulator 83. Thus, the end surface Wb of each wafer W can be reliably detected by regulating the angle of the optical axis A about the vertical axis, even in a case where wafers W of various shapes, various sizes, or both of various shapes and various sizes are handled on the load port 4.

Furthermore, the configuration that allows regulation of the angle of the optical axis A about the vertical axis is effective in a case where the end surface Wb of the wafer W is not straight in the up-down direction. More specifically, it is assumed that there is a cross section of the wafer W parallel to the up-down direction (see, e.g., FIG. 2A). In this cross section, the end surface Wb of the wafer W extends linearly in the up-down direction. For example, in a case where the end surface Wb is linear in this cross section, the portion of the end surface Wb that is approximately perpendicular to the optical axis A extends long in the up-down direction. Therefore, the laser light reflected by the end surface Wb is likely to be detected sufficiently by the light receiver 82, and the end surface Wb can be easily detected by the sensor 72. On the other hand, in a case where the upper and lower ends of the end surface Wb are rounded in the cross section, the portion of the end surface Wb that is approximately perpendicular to the optical axis A is relatively short in the up-down direction. Therefore, it may be difficult to the laser light reflected by the end surface Wb by using the light receiver 82. In this regard, according to present embodiment, the angle of the optical axis A about the vertical axis may be regulated. Therefore, when viewed from the up-down direction (see, e.g., FIG. 9A), the portion of the end surface Wb that is approximately perpendicular to the optical axis A may be obtained as wide as possible. In other words, even in a case where there is a demerit caused by the end surface Wb not being linear in the cross section, this demerit may be compensated for. Accordingly, it is possible to reliably detect the end surface Wb.

Furthermore, wafers W generally have a substantially circular cross section. Therefore, the configuration of the present embodiment, in which the angle of the optical axis A of each sensor 72 about the vertical axis is regulated and the optical axis A is arranged substantially perpendicular to the end surface Wb, is particularly effective for the load port 4 configured to handle the FOUP 100 accommodating the wafers W.

Next, modifications of the embodiment will be described. The same reference numerals will be used to designate components having the same configuration as those of the embodiment, and the description thereof will be omitted as appropriate.
(1) In the above-described embodiment, the control part 46 sequentially performs the scan with the first sensor 73 (step S101), the scan with the second sensor 74 (step S102), and the scan with the third sensor 75 (step S103). However, the present disclosure is not limited thereto. The control part 46 may be configured to simultaneously store the information on the detection results of all three sensors 72 in association with the position information of the detection part 61 in the up-down direction when the detection part 61 is initially moved from the upper end position to the lower end position. In a case where the control part 46 has such a function, it is possible to reduce the time required to obtain the information on all the positions of the first portion Wb1, the second portion Wb2, and the third portion Wb3 in the up-down direction.
(2) In the above-described embodiment, the three sensors 72 have substantially the same positions in the up-down direction. However, the present disclosure is not limited thereto. The position of one or more of the first sensor 73, the second sensor 74, or the third sensor 75 in the up-down direction may be different from the positions of other sensors 72 in the up-down direction. In this case, the control part 46 may be configured to be capable of correcting the position information of the three sensors 72 in the up-down direction. More specifically, the control part 46 may regard position information of a specific sensor 72 (e.g., the first sensor 73) in the up-down direction as information on a base position of the detection part 61 in the up-down direction. In this case, it is preferable that the control part 46 stores, for example, the following first distance information and second distance information in advance. The first distance information is relative distance information between the first sensor 73 and the second sensor 74 in the up-down direction. The second distance information is relative distance information between the first sensor 73 and the third sensor 75 in the up-down direction. It is preferable that the control part 46 corrects the position information of the second sensor 74 in the up-down direction by using the base position information and the first distance information. The control part 46 preferably corrects the position information of the third sensor 75 in the up-down direction by using the base position information and the second distance information. Such correction can suppress the occurrence of erroneous determinations due to positional deviations of the three sensors 72 in the up-down direction. The above process is effective, for example, in a case where it is necessary to make arrangement positions of the three sensors 72 in the up-down direction different for design or other reasons. Alternatively, the above correction is also effective, for example, in a case where a design error unintentionally causes a slight deviation in the arrangement positions of the three sensors 72 in the up-down direction.
(3) In the above-described embodiment, the control part 46 uses information on the length of the first portion Wb1 (hereinafter referred to as a first thickness) in the up-down direction as the information on the thickness of the wafer W. However, the present disclosure is not limited thereto. For example, the control part 46 may use information on the length of the second portion Wb2 (hereinafter referred to as a second thickness) in the up-down direction as the information on the thickness of the wafer W. The control part 46 may use both of the information on the first thickness and the information on the second thickness as the information on the thickness of the wafer W. In a case where both pieces of information are used as the information on the thickness of the wafer W, the control part 46 may, for example, compare an average value of the first thickness and the second thickness with a reference thickness.
(4) In the above-described embodiments, the detection part 61 includes three sensors 72. However, the present disclosure is not limited thereto. The detection part 61 may include four or more sensors 72. This may provide more detailed information about the deflection of the wafer W. Alternatively, the detection part 61 may include only one or two sensors 72. In this case, the scanner 45 may not include a left-right movement mechanism (not shown) configured to drive the detection part 61 to move in the left-right direction.
(5) The container mounted on the load port 4 is not limited to the FOUP 100. For example, a known open cassette (not shown) may be mounted on the load port 4. A diameter of the wafer W accommodated in the open cassette is, for example, approximately 200 mm. In a case where multiple types of containers are mounted on the load port 4 in this manner, it may be necessary to change the angle of the optical axis A of each sensor 72 about the vertical axis. In this case, the angle regulator 83 described above is particularly effective. Furthermore, the substrate accommodated in the container may include something other than the wafer W. The substrate may include, for example, a frame (not shown) to which the wafer W is fixed. Even in a case where such a frame is deflected slightly, the amount of deflection of the substrate can be detected. Alternatively, a substrate other than the wafer W and the frame (e.g., a glass substrate) may be accommodated in the container. A shape of the substrate may be a shape other than a substantially circular plate shape. For example, the substrate may have a substantially rectangular shape when viewed from the up-down direction.
(6) In the above-described embodiment, each sensor 72 is configured so that the angle of the optical axis A about the vertical axis can be regulated by the angle regulator 83. However, the present disclosure is not limited thereto. For example, the angle of the optical axis A about the vertical axis may be regulated only in the first sensor 73, the second sensor 74, or both of the first sensor 73 and the second sensor 74. Alternatively, the angle of the optical axis A of each sensor 72 about the vertical axis may be fixed.
(7) In the above-described embodiment, the angle of the optical axis A of each sensor 72 about the vertical axis is set to be approximately perpendicular to the end surface Wb of the wafer W in the FOUP 100. However, the present disclosure is not limited thereto. That is, the optical axis A may be tilted from a normal line (not shown) of the end surface Wb, as long as each sensor 72 is capable of detecting the end surface Wb.
(8) In the above-described embodiment, each sensor 72 is a laser sensor configured to use laser light as the detection light. However, the present disclosure is not limited thereto. One or more of the plurality of sensors 72 may be a known photoelectric sensor configured to use light other than laser light as the detection light.
(9) A sensor other than a laser sensor or a photoelectric sensor may be applied to one or more of the sensors 72. For example, a known reflective ultrasonic sensor configured to be capable of emitting and sensing an ultrasonic wave as a detection medium may be applied to the sensors 72.
(10) The detection part 61 may include, for example, three or more cameras (not shown) instead of the three or more sensors 72. The detection part 61 may have any device as long as being configured to be capable of detecting three or more portions of the end surface Wb of the wafer W that are spaced apart from each other in the left-right direction.
(11) In the above-described embodiment, the detection part 61 is driven to move integrally with the door support portion 53 in the up-down direction by the motor 58. However, the present disclosure is not limited thereto. The detection part 61 may be driven to move in the up-down direction by a drive source (not shown) separate from the motor 58.
(12) In the above-described embodiment, the load port 4 includes the control part 46. However, the present disclosure is not limited thereto. For example, the control device 5 of the EFEM 1 may control the load port 4. In this case, the control device 5 corresponds to the determiner of the present disclosure.
(13) The load port 4 may be mounted on equipment other than the EFEM 1.
(14) In the above-described embodiment, the scanner 45 including the detection part 61 is provided in the load port 4. However, the present disclosure is not limited thereto. For example, in the EFEM 1, the transfer robot 3 may include the detection part 61 instead of the load port 4. The transfer robot 3 may support the detection part 61 and drive the detection part 61 to move in the up-down direction and the front-rear direction. In this case, the EFEM 1 is a mapping device having a mapping function. In addition, in this case, the transfer robot 3 corresponds to the scanner of the present disclosure. The control device 5 may function as the determiner of the present disclosure and may perform the mapping process. As described above, the load port 4 may be mounted on equipment other than the EFEM 1. In other words, a mapping device (not shown) different from the EFEM 1 may include a load port (not shown) that does not include the scanner 45, a scanner (not shown) provided separately from the load port, and a determiner (not shown). The mapping device may include components corresponding to the base and the mounter of the present disclosure instead of the load port.

### EXPLANATION OF REFERENCE NUMERALS

4: load port, 43: support frame (base), 44: mounter, 45: scanner, 46: control part (determiner), 58: motor (driver), 71: main body (support portion), 73: first sensor, 74: second sensor, 75: third sensor, 81: light emitter, 82: light receiver, 100: FOUP (container), 113L: support portion (second support portion), 113R: support portion (first support portion), A: optical axis, W: wafer (substrate), Wb: end surface, Wb1: first portion, Wb2: second portion, Wb3: third portion

What is claimed is:

1. A load port comprising:
a base having a fixed installation position;
a mounter attached to the base and configured such that a container configured to accommodate a plurality of substrates arranged in a vertical direction is mounted on the mounter;
a scanner configured to be capable of detecting the plurality of substrates accommodated in the container; and
a determiner configured to be capable of making a determination regarding a state of each of the plurality of substrates detected by the scanner,
wherein the scanner is configured to be capable of detecting a first portion, a second portion, and a third portion of an end surface of each of the plurality of substrates, the first portion, the second portion, and the third portion being spaced apart from one another in an extension direction of the end face of each of the plurality of substrates, while a fixed state, in which the container is mounted on the mounter and an angle of the container about a vertical axis with respect to the base is fixed, is maintained, and
wherein the determiner is configured to determine whether each of the substrates is normally accommodated in the container by using information on a first position which is a vertical position of the first portion and information on a second position which is a vertical position of the second portion, and calculate an amount of vertical deflection of a substrate normally accommodated in the container among the plurality of substrates by using the information on the first position, the information on the second position, or both of the information on the first position and the information on the second position, and information on a third position which is a vertical position of the third portion.

2. The load port of claim 1, wherein the scanner includes: a first sensor configured to be capable of detecting the first portion; a second sensor configured to be capable of detecting the second portion and different from the first sensor; a third sensor configured to be capable of detecting the third portion and different from the first sensor and the second sensor; a support portion configured to support the first sensor, the second sensor, and the third sensor; and a driver configured to be capable of driving and moving the support portion in the vertical direction.

3. The load port of claim 1, wherein when the container is in the fixed state, a first support portion configured to support each of the plurality of substrates inside the container is arranged on one side of a center of the container in a predetermined container width direction perpendicular to the vertical direction,
a second support portion configured to support each of the plurality of substrates inside the container is arranged on the other side of the center of the container in the container width direction,
the first portion is arranged closer to the first support portion than the center of the container in the container width direction,
the second portion is arranged closer to the second support portion than the center of the container in the container width direction, and
the third portion is arranged between the first portion and the second portion in the container width direction.

4. The load port of claim 2, wherein when the container is in the fixed state, a first support portion configured to support each of the plurality of substrates inside the container is arranged on one side of a center of the container in a predetermined container width direction perpendicular to the vertical direction,
a second support portion configured to support each of the plurality of substrates inside the container is arranged on the other side of the center of the container in the container width direction,
the first portion is arranged closer to the first support portion than the center of the container in the container width direction,
the second portion is arranged closer to the second support portion than the center of the container in the container width direction, and
the third portion is arranged between the first portion and the second portion in the container width direction.

5. The load port of claim 1, wherein the scanner includes:
a reflective optical sensor including a light emitter configured to emit detection light for detecting the end surface and a light receiver configured to sense the detection light reflected by the end surface; and
an angle regulator configured to be capable of regulating an angle of an optical axis of the detection light emitted from the light emitter about the vertical axis.

6. The load port of claim 2, wherein the scanner includes:
a reflective optical sensor including a light emitter configured to emit detection light for detecting the end surface and a light receiver configured to sense the detection light reflected by the end surface; and
an angle regulator configured to be capable of regulating an angle of an optical axis of the detection light emitted from the light emitter about the vertical axis.

7. The load port of claim 1, wherein the scanner includes a plurality of reflective optical sensors each including a light emitter configured to emit detection light for detecting the end surface and a light receiver configured to sense the detection light reflected by the end surface,
wherein the plurality of substrates include a plurality of wafers which are semiconductor substrates, and
wherein the plurality of reflective optical sensors include: a first sensor arranged so that an optical axis of the detection light emitted from the light emitter is perpendicular to the first portion of the end surface of the wafer; a second sensor arranged so that the optical axis is perpendicular to the second portion of the end surface, the second sensor being different from the first sensor; and a third sensor arranged so that the optical axis is perpendicular to the third portion of the end surface, the third sensor being different from the first sensor and the second sensor.

8. The load port of claim 2, wherein the scanner includes a plurality of reflective optical sensors each including a light emitter configured to emit detection light for detecting the end surface and a light receiver configured to sense the detection light reflected by the end surface,
wherein the plurality of substrates include a plurality of wafers which are semiconductor substrates, and
wherein the plurality of reflective optical sensors include: a first sensor arranged so that an optical axis of the detection light emitted from the light emitter is perpendicular to the first portion of the end surface of the wafer; a second sensor arranged so that the optical axis is perpendicular to the second portion of the end surface, the second sensor being different from the first sensor; and a third sensor arranged so that the optical axis is perpendicular to the third portion of the end surface, the third sensor being different from the first sensor and the second sensor.

9. The load port of claim 3, wherein the determiner uses information about a length of at least one of the first portion or the second portion in an up-down direction as information about a thickness of the substrate.

10. The load port of claim 1, wherein the scanner includes: a reflective optical sensor including a light emitter configured to emit detection light for detecting the end surface and a light receiver configured to sense the detection light reflected by the end surface, and
wherein a length of a beam of the detection light emitted from the light emitter in an up-down direction is shorter than a thickness of the substrate.

11. The load port of claim 2, wherein the scanner includes: a reflective optical sensor including a light emitter configured to emit detection light for detecting the end surface and a light receiver configured to sense the detection light reflected by the end surface, and
wherein a length of a beam of the detection light emitted from the light emitter in an up-down direction is shorter than a thickness of the substrate.
